(19) United States
(12) Patent Application Publication
(10) Pub. No.: US 2010/0162300 A1
(43) Pub. Date: Jun. 24, 2010

(54) Methods And Systems For Creating An Emergency Alert Channel

(75) Inventors: Leonardo Velazquez, Plano, IL (US); James L. Ford, III, San Antonio, TX (US)

Correspondence Address: AT&T Legal Department - WW, Patent Docketing Room 2A-207, One AT&T Way, Bedminster, NJ, 07921, US

(73) Assignee: AT&T Intellectual Property I,L.P., Reno, NV (US)

(21) Appl. No.: 12/339,250

(22) Filed: Dec. 19, 2008

(51) Int. Cl. H04N 7/025

(52) U.S. Cl. 725/33

(57) ABSTRACT

A video stream or interface that may include an indication of a broadcasted alert message and/or detailed information associated with a broadcasted alert message may be generated and/or rendered. The video stream or interface may be generated and/or rendered by a content provider and then provided to a consumer via, for example, a content device such that the video stream or interface may be accessed via a broadcast channel or an on-demand channel established by the content provider. Alternatively, the video stream or interface may be generated and/or rendered by the content device such that the video stream or interface may be accessed via an option such as a channel, menu option, or the like provided by the content device.

### BACKGROUND

Emergency Alert Systems (EAS) provide messages indicative of a variety of types of alerts including, for example, weather conditions, disasters, AMBER (America's Missing: Broadcast Emergency Response) alerts, and/or alerts issued by the Government. Typically, such EAS alert messages are provided to, for example, television customers by issuing an alerting tone and displaying an overlay message on a local channel, a national channel, Video on Demand content, Pay Per View content, or options such as a Menu, a Guide, or the like. Unfortunately, such EAS messages may be missed and/or dismissed by the customers and may not be able to be viewed at a later time.

### SUMMARY

Disclosed herein are systems and methods for providing notification of alert messages. For example, a broadcasted alert message may be received by a content provider such as a television station, a cable provider, a satellite provider, an Internet Protocol Television (IPTV) provider, or the like from, for example, a source that may issue alert messages. In one embodiment, the content provider may generate a video stream that may include an indication of the broadcasted alert message, alert information associated with the broadcasted alert message, or the like. The content provider may then provide access to the video stream via, for example, a broadcast channel such that upon selecting the broadcast channel the video stream may be rendered. Alternatively, the content provider may generate an interface that may include an indication of the broadcasted alert message, alert information associated with the broadcasted alert message, or the like. The content provider may then provide the interface via an on-demand channel that may be selected.

According to another embodiment, a content device such as a set top box, a set top unit, a Digital Video Recorder (DVR), a Personal Video Recorder (PVR), a television, or the like may provide one or more interfaces that may include an indication of the broadcasted alert message, alert information associated with the broadcasted alert message, or the like. For example, a broadcasted alert message may be received by a content provider. The content provider may provide the broadcasted alert message to the content device. The content device may then render one or more interfaces that may include an indication of the broadcasted alert message, alert information associated with the broadcasted alert message, or the like. According to an example embodiment, the one or more interfaces may be accessed by, for example, selecting an option such as a channel, a Menu option, a Guide option, a link, or the like such that the one or more interfaces may be output via the content device.

### BRIEF DESCRIPTION OF THE DRAWINGS

FIG. 1 depicts an example embodiment of a system for providing an alert message to a content device.

FIG. 2 depicts an example embodiment of a content device that may provide an alert message.

FIG. 3 depicts an example embodiment of a notification of an alert message that may be provided over content.

FIG. 4 depicts an example embodiment of an interface that may provide an indication of alert messages that may have been broadcast.

FIG. 5 depicts an example embodiment of an interface for a selected alert message.

FIG. 6 depicts a flow diagram of an example method for providing notification of a broadcasted alert message.

FIG. 7 depicts a flow diagram of another example method for providing notification of a broadcasted alert message.

### DETAILED DESCRIPTION OF ILLUSTRATIVE EMBODIMENTS

As will be described herein, Emergency Alert System (EAS) alert messages may be provided to a content device such as a television, set top box, Digital Video Recorder (DVR), Personal Video Recorder (PVR), computing device, or the like. In an example embodiment, the EAS alert messages may be provided by, for example, audiovisual stream via broadcast channel to the content device. A customer may then access the alert channel by, for example, selecting a channel number associated with the alert channel to view the audiovisual stream of the EAS alert messages. According to another example embodiment, the EAS alert messages may be provided via an application such as a device-based application, a browser application, or the like that may be stored on and executed by the content device. The customer may launch the application by, for example, selecting a shortcut or option associated with the application. Upon launching the application, the EAS alert messages may be provided to the customer.

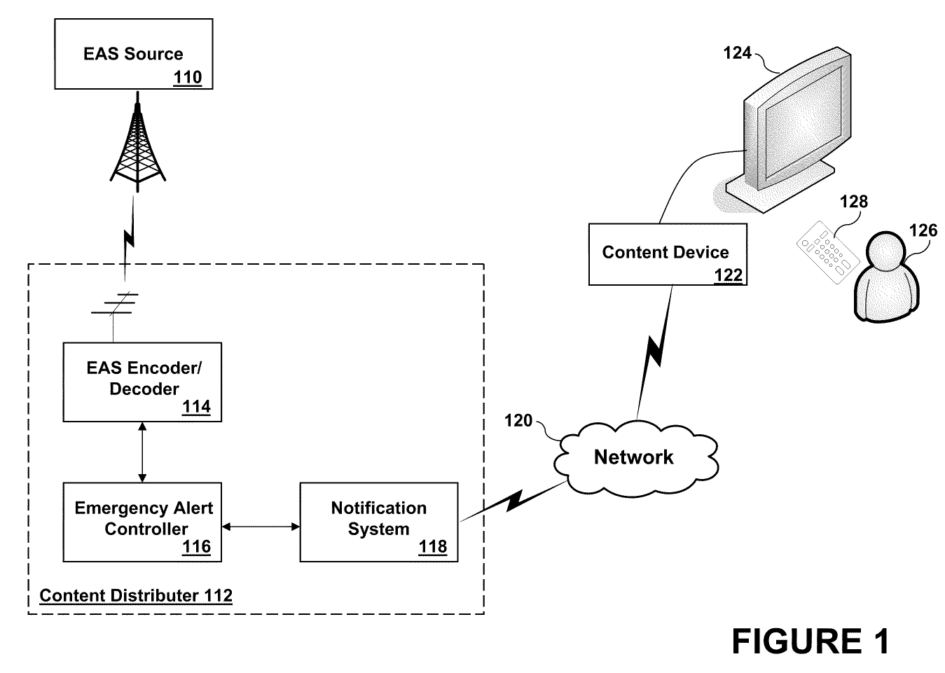

FIG. 1 depicts an example embodiment of a system for providing an alert message to a content device 122. The alert message may include general alert types such as general weather alerts, general natural disaster alerts, general government alerts, or the like and/or a specific alert types such as child abduction (e.g., AMBER—America's Missing: Broadcast Emergency Response), geophysical e.g., landslide, meteorological (e.g., windstorm, tornado, hurricane, tsunami, lightning storms, thunderstorms, hurricanes, freezing rain, blizzards, fog), general emergency and public safety, law enforcement, military, homeland and local/private security, rescue and recovery, fire suppression and rescue, medical and public health, pollution and other environmental conditions, public and private transportation, utility, telecommunication, other non-transport infrastructure, CBRNE (Chemical, Biological, Radiological, Nuclear or Explosive) threat or attack, and/or system test, or the like. The alert message may also include alert severity levels such as warnings, watches, advisories, or the like that may be associated with each alert type, for example.

As shown in FIG. 1, an Emergency Alert System (EAS) source 110 may be in communication with a content distributor 112 via a communication link. The EAS source 110 may include an emergency alert broadcast station that may transmit and/or generate an alert message such as an EAS alert message. According to an example embodiment, the EAS source 110 may be the National Weather Service (NWS), a local source station, a state source station, or any other suitable source such as the Internet that may generate and/or broadcast an alert message.

The EAS source 110 may broadcast an alert message to the content distributor 112. The content distributor 112 may be a television station, a cable provider, a satellite provider, an Internet Protocol Television (IPTV) provider, or any other suitable entity that may provide content such as audiovisual broadcasts including movies, television programs, or the like to a customer.

According to one embodiment, the content distributor 112 may include an EAS Encoder/Decoder 114 that may receive a broadcasted alert message from the EAS source 110. For example, the EAS Encoder/Decoder 114 may include a reception device such as an antenna that may continuously monitor for broadcasted alert messages that may be provided by, for example, the EAS source 110, the Internet, a Local Area Network (LAN), a Virtual Private Network (VPN), a telephone connection, or the like. The EAS Encoder/Decoder 114 may be configured to process and/or relay the broadcasted alert messages that may be received thereby. For example, the EAS Encoder/Decoder 114 may decode a broadcasted alert message such that the content distributor 112 may provide the broadcasted alert messages to customers, which will be described in more detail below.

The content provider 112 may further include an Emergency Alert Controller (EAC) 116 that may be in communication with the EAS Encoder/Decoder 114. In one embodiment, the broadcasted alert messages that may be received and/or processed by the EAS Encoder/Decoder 114 may then be provided to the EAC 116. The EAC 116 may include hardware components such as servers, controllers, databases, processors, storage drives, registers, cache, RAM memory chips, ROM memory chips, data buses, or the like and/or software components such as operating systems, database management applications, or the like that may control the hardware components.

According to one embodiment, the EAC 116 may multicast the broadcasted alert messages to a notification system 118. The notification system 118 may include hardware components such as servers, controllers, databases, processors, storage drives, registers, cache, RAM memory chips, ROM memory chips, data buses, or the like and/or software components such as operating systems, database management applications, or the like that may control the hardware components. For example, the notification system 118 may include a database that may receive and store the broadcasted alert messages that may be multicast by the EAC 116; a controller that may access and provide the stored broadcasted alert messages in the database to a server; and the server that may route the broadcasted alert messages provided by the controller to a customer of the content provider 112. Thus, in an example embodiment, the notification system 118 may provide broadcasted alert messages to a customer of the content provider 112. According to an example embodiment, the notification system 118 may provide the broadcasted alert messages to the customer via a video stream such as an “On Demand” video stream or a continuous loop video stream. The customer may access the video stream by, for example, selecting a channel number or an “On Demand” option that may be used to provide the video stream, which will be described in more detail below.

As shown in FIG. 1, the content provider 112 may be in communication with a content device 122 via a network 120. The network 120 may be any type of communication network such as an IPTV network, a cable network, the Internet, a Local Area Network (LAN), a Wide Area Network (WAN), a fiber optic network, a telephone network, or the like. According to one embodiment, the network 120 may be operated by, for example, the content provider 112.

The content provider 112 may provide the content and/or the broadcasted alert messages to a customer 126 via the content device 122. According to example embodiments, the content device 122 may be any appropriate device that may receive, process, and/or decode a signal that may include the content and/or the broadcasted alert message provided by the content provider 112. For example, the content device 122 may include a set top unit, a set top box, a television, a gaming system, a computer, a DVR, a PVR, a DVD player, or the like.

As shown in FIG. 1, in one embodiment, the content device 122 may be connected to an audiovisual display 124 such as a monitor, television, or the like that may display the content and/or the broadcasted alert messages provided by the content provider 112 to the content device 122. For example, according to such an embodiment, the content device 122 may include a set top box, a set top unit, a gaming system, a DVR, a PVR, a computer, or the like that may be connected to the audiovisual display 124 such that the customer 126 may view the content and/or the broadcasted alert messages via the audiovisual display 124.

In another embodiment, the content device 122 may include an audiovisual display integrated therein. For example, according to such an embodiment, the content device 122 may include a television, a monitor, a projector, or the like that may display the content and/or the broadcasted alert messages provided by the content provider 112 such that the customer 126 may view the content and/or the broadcasted alert messages via the audiovisual display integrated in the content device 122.

To access the content and/or the broadcasted alert messages, the customer 126 may interact with, for example, an input device 128 such as a remote control. For example, the customer may use the input device 128 to turn on the content device 122, change content being displayed by the content device 122 and/or the audiovisual device 124 connected thereto, and/or access the broadcasted alert messages.

According to one embodiment, the customer 126 may interact with the input device 128 to select a channel or an “on demand” option to access the video stream provided by the notification system 118 that may include the broadcasted alert messages. In another example embodiment, the customer may interact with the input device 128 to launch an alert messages application that may be executed by the content device 122 to provide an interface with the broadcasted alert messages, which will be described in more detail below

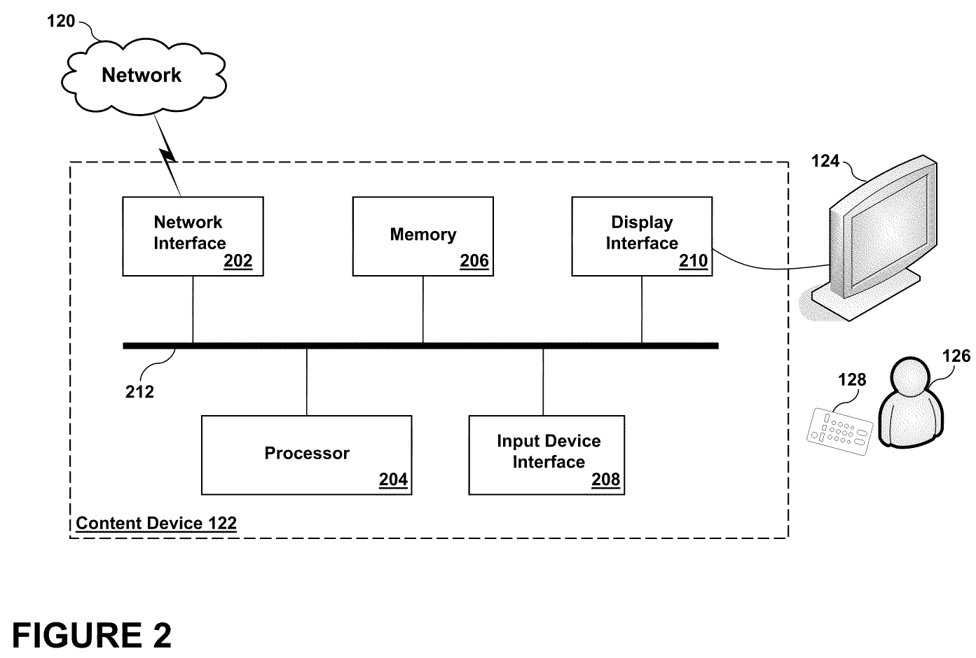

FIG. 2 depicts an example embodiment of the content device 122 that may provide an alert message received from the content distributor 112 to the customer 126. The content device 122 may include hardware components such as a processor, a display interface including, for example, a graphics card, a storage component, a memory component, a network component, an input interface, or the like. The content device 122 may also include software components such as an operating system that may control the hardware components. For example, as shown in FIG. 2, the content device 122 may include a network interface 202, a processor 204, a memory component 206, an input device interface 208, and a display interface 210.

According to example embodiments, the content device 122 may be capable of executing a variety of computing applications. The computing applications may include an application such as a browser application, an applet, a program, or other instruction set operative on the content device 122 to perform at least one function, operation, and/or procedure including at least one function, operation, and/or procedure that may receive, decode, and/or display the broadcasted alert messages to the customer. According to an example embodiment, the computing applications may include an alert message application that may be executed by the content device 122. The alert message application may include one or more interfaces such as user interfaces that may provide the consumer 128 with access to broadcasted alert messages, which will be described in more detail below.

The content device 122 may be controlled by computer readable instructions that may be in the form of, for example, software. The computer readable instructions may include instructions for the content device 122 to store and access the computer readable instructions themselves. Such software may be executed within the processor 204 to cause the content device 122 to perform the processes or functions associated therewith. According to one embodiment, the processor 204 may include a standardized processor, a specialized processor, a microprocessor, or the like that may execute the computing applications and that may decode the signal that may include the content and/or broadcasted alert messages for display to the customer 126.

In operation, the processor 204 may fetch, decode, and/or execute instructions and may transfer information to and from other resources via a main data-transfer path or a system bus 212. Such a system bus may connect the components in the content device 122 and may define the medium for data exchange.

The content device 122 may further include a memory component 206 coupled to the system bus 212. According to an example embodiment, the memory component 206 may include random access memory (RAM), read only memory (ROM), cache, Flash memory, a hard disk, or any other suitable storage component. The memory component 206 may include circuitry that allows information to be stored and retrieved. In one embodiment, the memory component 206 may store the computing applications that may be executed by the processor 204. Additionally, the broadcasted alert messages may be stored in, for example, the memory component 206 upon being decoded by the processor 204 such that the broadcasted alert message stored therein may be accessed by the consumer 126.

In addition, the content device 122 may include an input device interface 208 that may be responsible for providing communication between the processor 204 and the input device 128 such as a remote control that may be used by the customer 126 to control the content device 122.

The content device 122 may further include an audiovisual display interface 210 that may include electronic components such as a graphics card, a sound card, or the like that may generate an audiovisual signal that may be provided to the audiovisual device 124. According to one embodiment, the audiovisual device 124 may be connected to the audiovisual display interface 210 via, for example, an S-Video cable, a coaxial cable, an HDMI cable, a DVI cable, a VGA cable, or the like.

As described above, the audiovisual display 124 may be used to display visual output associated with the signal received from the content provider 122. Such visual output may include the content including the television programs, movies, or the like and/or the broadcasted alert messages.

Further, the content device 122 may include a network interface 202 that may be used to connect the content device 122 to an external communication network such as the network 120. According to an example embodiment, the network interface 202 may receive the signal that may include content and/or the broadcasted alert message provided by the content provider 112 via the network 120. The network interface 202 may provide the received signal to the processor 204 via the system bus 212 such that the processor 204 may process, decode, and/or manipulate the signal as described above.

In one embodiment, the broadcasted message that may be processed, decoded, and/or manipulated by the processor 204 may then be provided to the memory component 206 via the system bus 212 to be stored therein. As described above, the content device 122 may include an alert messages application that may be executed by the processor 204. The consumer 126 may launch the alert messages application by interacting with the input device 128. Upon launching the alert messages application the processor 204 may then access the broadcasted alert messages stored in the memory component 206 to the display interface 210 such that the content and/or the broadcasted alert message may be output via the audiovisual device 124.

According to another embodiment, the broadcasted message that may be processed, decoded, and/or manipulated by the processor 204 may provided directly to the display interface 210 via the system bus 212. For example, the broadcasted alert messages may stored remotely by, for example, the notification system 118 of the content provider 112. The customer 126 may then interact with the input device 128 to access the broadcasted alert messages stored in the notification system 118 as described above.

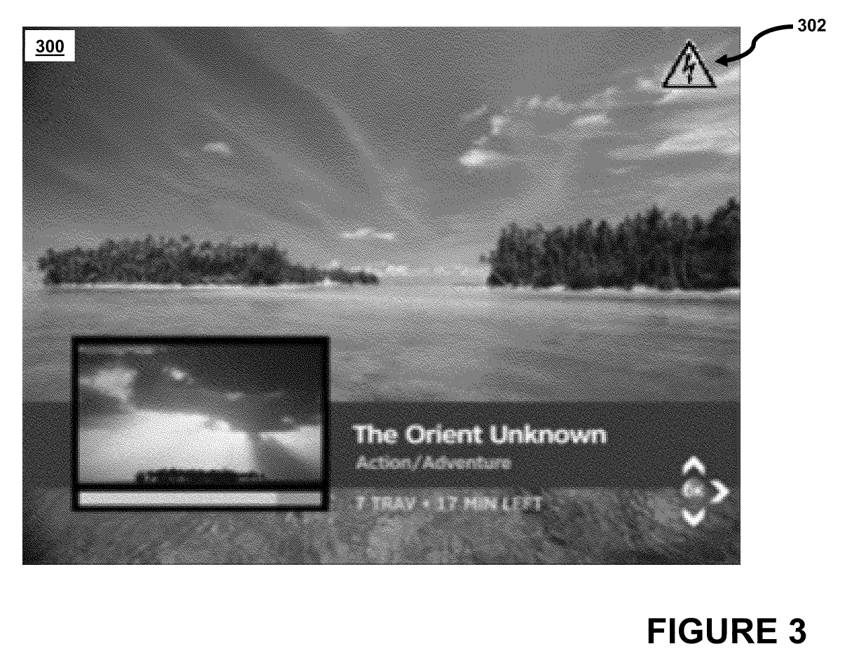

FIG. 3 depicts an example embodiment of a notification 302 of a broadcasted alert message provided over content 300 being broadcast by, for example, the content provider 112. As shown in FIG. 3, a notification 302 that may include, for example, a graphical icon may be provided over the content 300. As described above, the content 300 may include, for example, television shows, movies, or the like that may be broadcast by and/or accessed from the content provider 112. According to one embodiment, the notification 302 may be a visual indication, an audiovisual indication, or the like to the consumer 126 that an alert message has been broadcast.

In one embodiment, the graphical icon associated with the notification 302 may be indicative of the type of alert message being broadcast. For example, different graphical icons may be associated with each type of alert message such that the notification 302 displayed over the content 300 may depend on the type of alert message being broadcast.

Additionally, the notification 302 may include a link to the alert channel or an application such as browser application, alert messages application, or the like. For example, in one embodiment, the customer 126 may interact with the input device 128 to select the notification 302. Upon selecting the notification 302, the customer 126 may be directed to the alert channel or the application such that the customer 126 may view broadcasted alert messages via a video stream, an interface, or the like.

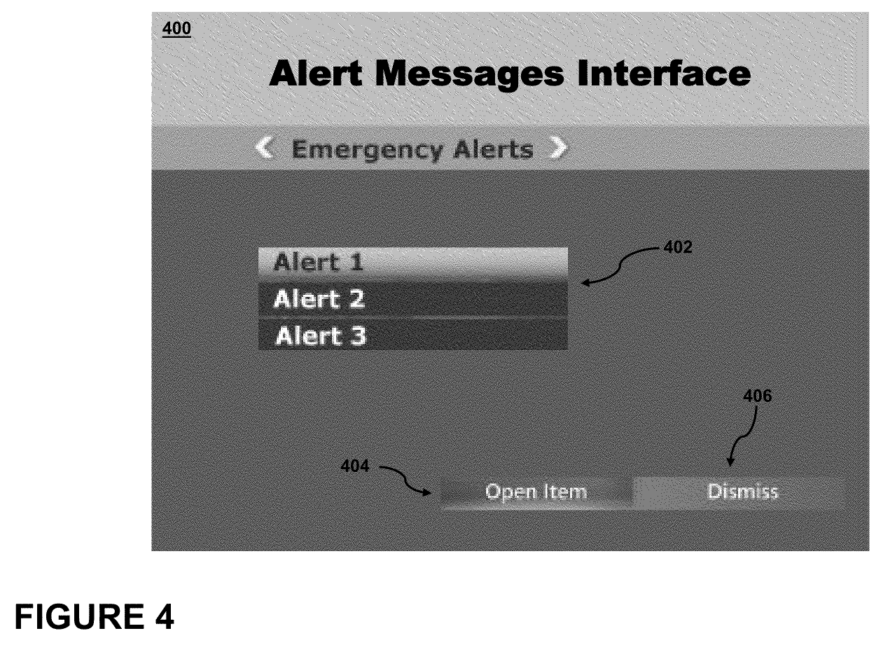

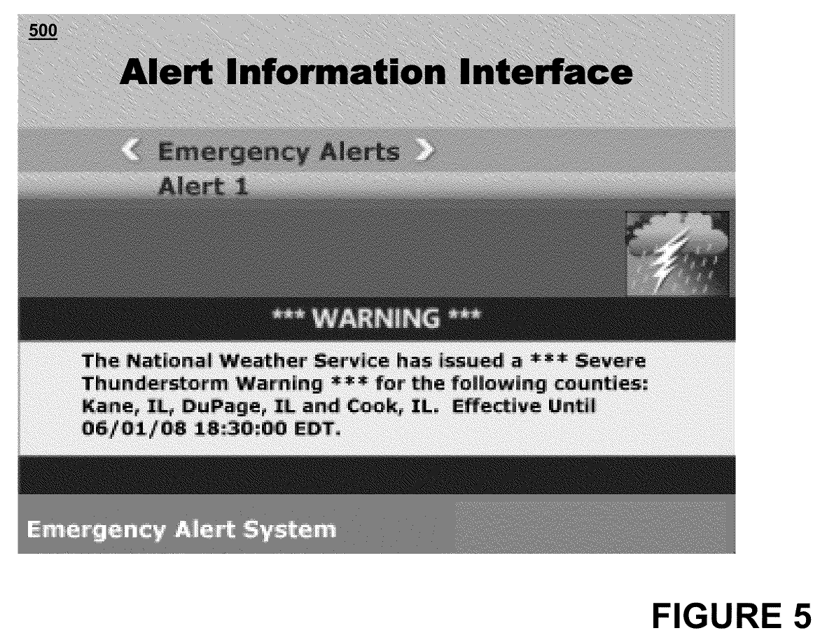

FIG. 4 depicts an example embodiment of an alert messages interface 400 that may provide an indication or summary of broadcasted alert messages. The alert messages interface 400, as well as the interface described below in FIG. 5, may be a video stream that may include a visual and/or audio indication of alert messages that may have been broadcast, a web page generated using, for example, HTML, Java, or the like that may include a visual and/or audio indication of alert messages that may have been broadcast, or any other suitable interface such as an application user interface that may provide a visual and/or audio indication of alert messages that may have been broadcast.

As shown in FIG. 4 the alert messages interface 400 may include an alert indication area 402. According to one embodiment, the alert indication area 402 may include an indication of active or broadcasted alerts such as a list of active or broadcasted alert messages. For example, as shown in FIG. 4 the alert indication area 402 may include indications “Alert 1,” “Alert 2,” and “Alert 3.” Each of “Alert 1,” “Alert 2,” and “Alert 3” may be an identifier such as a name, a type of an alert, or the like associated with an alert message that may have been broadcast by, for example, the EAS source 110 to the content distributor 112 as described above with respect to FIG. 1. Additionally, if no alert messages have been broadcast, the alert indication area 402 may include a message indicative that there have been no alert messages broadcasted

In one embodiment, each of “Alert 1,” “Alert 2,” and “Alert 3” may be selected to view detailed information associated with the selected alert messages. For example, in one embodiment, each of the “Alert 1,” “Alert 2,” and “Alert 3” may include an option such a link that may be selected such that the user may be directed to view detailed information associated with the selected broadcasted alert message.

As shown in FIG. 4, according to another embodiment, the alert messages interface 400 may include an open alert option 404. The open alert option 404 may be, for example, selected to view detailed information associated with one of the broadcasted alert messages displayed in the alert indication area 402. For example, a customer such as the consumer 126 described above with respect to FIGS. 1 and 2 may interact with an input device such as the input device 128 to highlight or select one of the broadcasted alert messages such as “Alert 1” in the alert indication area 402. Upon highlighting or selecting, for example, “Alert 1” in the alert indication area 402, the consumer may then interact with the input device to select the open alert option 404 such that the consumer may be directed to view detailed information associated with, for example, “Alert 1,” which will be described in more detail below. According to an example embodiment, the

The alert messages interface 400 may further include an dismiss alert option 406. The dismiss alert option 406 may be, for example, selected to dismiss one or more of the broadcasted alert messages displayed in the alert indication area 402. For example, the customer such as the consumer 126 described above with respect to FIGS. 1 and 2 may interact with the input device such as the input device 128 to highlight or select one of the broadcasted alert messages such as “Alert 1” in the alert indication area 402. Upon highlighting or selecting, for example, “Alert 1” in the alert indication area 402, the consumer may then interact with the input device to select the dismiss alert option 406 such that “Alert 1” may be removed from the indication area 402. According to an example embodiment, the consumer may dismiss one or more of the broadcasted alert messages displayed in the alert indication area 402 if, for example, the consumer already viewed detailed information associated with the alert by selecting the alert in the alert indication area 402 and the open alert option 404 as described above or previously viewed and/or heard information associated with the alert through other sources.

FIG. 5 depicts an example interface of an alert information interface 500 that may include detailed information associated with a broadcasted alert message. As described above with respect to FIG. 4, a broadcasted alert message such as “Alert 1” may be selected from, for example, the alert indication area 402 of the interface 400. Upon selecting the broadcasted alert messages such as “Alert 1” as described above, the alert information interface 500 may be provided to a consumer such as the consumer 126. As shown in FIG. 5, the alert information interface 500 may include detailed information associated with the selected broadcasted alert message such as “Alert 1.” For example, the alert information interface 500 may include full text and audio including, for example, the EAS source such as the EAS source 110 issuing the alert, the location affected by the alert, the effective time of the alert, the type of alert, the severity of the alert, or the like such that the consumer such as the consumer 126 may view and/or hear detailed information of the selected broadcasted alert message such as “Alert 1.”

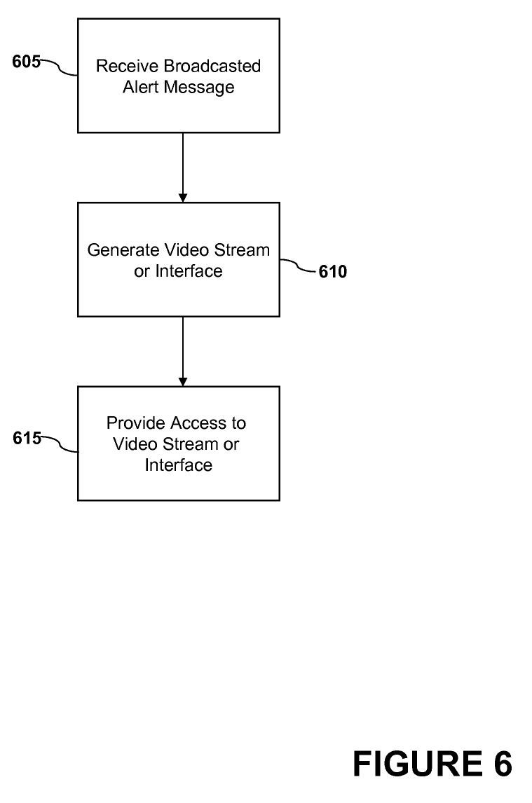

FIG. 6 depicts a flow diagram of an example method 600 for providing a notification of a broadcasted alert message. The example method 600 may be implemented using, for example, the notification system 118 associated with the content provider 112 described with respect to FIG. 1. At 605, a broadcasted alert message may be received by a content provider such as the content provider 112. According to an example embodiment, the content provider may be a television station, cable provider, satellite provider, IPTV provider, or the like that may provide audiovisual content such as television shows, movies, music, or the like. According to an example embodiment, the content provider may include systems such as the EAS Encoder/Decoder 114, the EAC 116, and the notification system 118 described above with respect to FIG. 1. For example, the content provider may include the EAS Encoder/Decoder 114, the EAC 116, and the notification system 118 that may receive and process a broadcasted alert message that may be received from the source such as EAS source 110.

According to one embodiment, the content provider may provide a notification such as the notification 302 described above with respect to FIG. 3 of the received broadcasted alert message over the audiovisual content. For example, the content provider may provide a graphical icon over the audiovisual content being broadcast to provide an indication or notification of the broadcasted alert message.

At 610, a video stream or interface may be generated by, for example, the content provider. For example, a system such as the notification system 118 of the content provider may generate a video stream or interface such as the interface 400 described above with respect to FIG. 4. According to an example embodiment, the video stream or interface may provide an indication of the received broadcasted alert message. Additionally, the video stream or interface may provide an option to view alert information associated with the broadcasted alert message received at 605.

At 615, the content provider may provide access to the video stream or interface. According to one embodiment, the content provider may provide access to the video stream or interface via a broadcast channel. In an example embodiment, the broadcast channel may be dedicated to providing access to the video stream or interface such that the video stream or interface, not audiovisual content, may provided via the broadcast channel. Alternatively, the content provider may provide access to the video stream or interface via an on-demand option.

The content provider may provide access to the video stream or interface via the broadcast channel or the on-demand option using a content device such as the content device 122 described above with respect to FIGS. 1 and 2. The content device may include a set top unit, a set top box, a television, a gaming system, a computer, a DVR, a PVR, a DVD player, or the like. A consumer such as the consumer 126 may interact with an input device such as the input device 128 described above with respect to FIGS. 1 and 2 to select the broadcast channel or the on-demand option such that the content device may be tuned to the broadcast channel or on-demand option. In one embodiment, a selection of the broadcast channel or the on-demand option may also be received by the content provider such that the video stream or interface may rendered via the broadcast channel or the on-demand option.

According to an example embodiment, the content provider may also generate or render another video stream that includes alert information. As described above, the video stream or interface generated at 610 may provide an option to view alert information associated with the broadcasted alert message received at 605. The content provider may provide another video stream or interface such as the interface 500 described above with respect to FIG. 5 that includes the alert information via the broadcast channel or on-demand option. According to one embodiment, the video stream or interface that includes the alert information may be rendered via the broadcast channel or on-demand option upon selection of the option that may be provided in the video stream or interface such as the interface 400 described above with respect to FIG. 4 generated at 610.

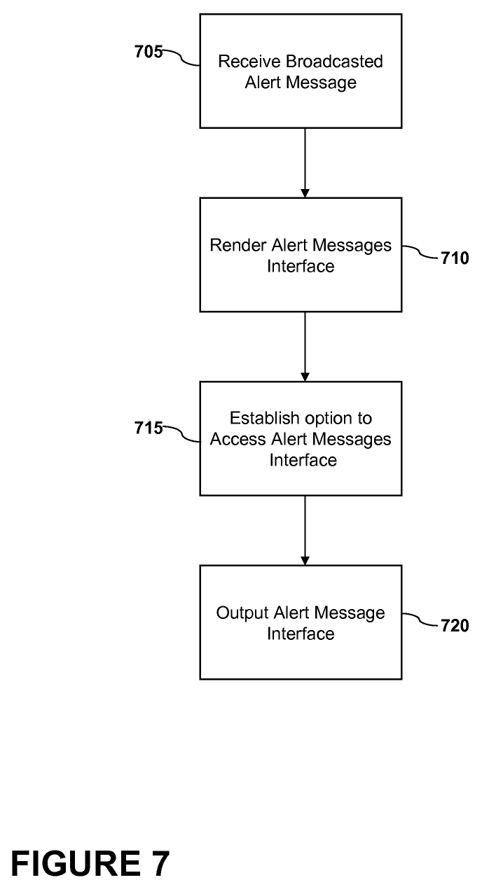

FIG. 7 depicts a flow diagram of another example method for providing a notification of a broadcasted alert message. The example method 700 may be implemented using, for example, the content device 122 described with respect to FIGS. 1 and 2. At 705, a broadcasted alert message may be received by for example a content device such as the content device 122. As described above, the content device may include a set top unit, a set top box, a television, a gaming system, a computer, a DVR, a PVR, a DVD player, or the like.

According to one embodiment, the broadcasted alert message may be received from a content provider such as the content provider 112 described above with respect to FIG. 1. The content provider may be a television station, cable provider, satellite provider, IPTV provider, or the like that may provide audiovisual content such as television shows, movies, music, or the like as well as broadcasted alert messages that may be received from a source such as the EAS source 110 described above with respect to FIG. 1 to the content device such that a consumers such as the consumer 126 may view the audiovisual content and/or the broadcasted alert message.

In an example embodiment, the content device may provide a notification such as the notification 302 described above with respect to FIG. 3 of the received broadcasted alert message over the audiovisual content. For example, the content provider may provide a graphical icon over the audiovisual content being broadcast to provide an indication or notification of the broadcasted alert message.

At 710, the content device may render an alert messages interface such as the interface 400 described above with respect to FIG. 4. According to an example embodiment, the alert messages interface may provide an indication of the received broadcasted alert message. Additionally, the alert messages interface may provide an option to view alert information associated with the broadcasted alert message received at 705.

At 715, the content device may establish an option to access the alert messages interface. For example, the content device may establishes a virtual channel. The virtual channel may include, for example, a channel created locally by the content device that may be selected to view the alert messages interface. Alternatively, the content device may also establish a menu option or the like that may be selected to view the alert messages interface.

At 720, the alert messages interface may be output via the option established at 715. For example, a consumer such as the consumer 126 may interact with an input device such as the input device 128 described above with respect to FIGS. 1 and 2 to select the option such as the channel or the menu option. Upon selection of the established option, the content device may output and display the alert messageS interface to the consumer.

In one embodiment, the content device may also render an alert information interface such as the interface 500 described above with respect to FIG. 5 that includes the alert information. For example, as described above, the alert messages interface rendered at 710 may provide an option to view alert information associated with the broadcasted alert message received at 705. According to one embodiment, upon selection of the option to view alert information provided on the alert messages interface rendered at 710, the alert information interface may be output via the established option such as the virtual channel or menu option.

It should be understood that the various techniques described herein may be implemented in connection with hardware or software or, where appropriate, with a combination of both. Thus, the methods and apparatus of the subject matter described herein, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that—in the case where there is more than one single medium—there is no requirement that any particular part of the code be stored on any particular medium. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the subject matter described herein, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although example embodiments may refer to utilizing aspects of the subject matter described herein in the context of one or more stand-alone computer systems such as set-top boxes, televisions, notification systems, or the like, the subject matter described herein is not so limited, but rather may be implemented in connection with any computing environment, such as a network or distributed computing environment. Still further, aspects of the subject matter described herein may be implemented in or across a plurality of processing chips or devices, and storage may similarly be affected across a plurality of devices. Such devices might include personal computers, network servers, handheld devices, supercomputers, or computers integrated into other systems such as automobiles and airplanes.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computer-implemented method of providing an alert message, the method comprising:
receiving at least one broadcasted alert message;
generating a first video stream comprising an indication of the at least one broadcasted alert message; and
providing access to the first video stream via a dedicated broadcast channel.

2. The method of claim 1, further comprising providing a notification of the at least one broadcasted alert message over audiovisual content.

3. The method of claim 2, wherein the notification comprises a graphical icon, and wherein the graphical icon is a pictorial representation of the at least one broadcasted alert message.

4. The method of claim 1, further comprising:
receiving a selection of the dedicated broadcast channel; and
rendering the first video stream upon receiving the selection of the dedicated broadcast channel.

5. The method of claim 4, wherein the first video stream comprising the indication of the at least one broadcasted alert message is generated in response to the selection of the dedicated broadcast channel.

6. The method of claim 4, wherein the first video stream comprises an option to view alert information associated with the at least one broadcasted alert message.

7. The method of claim 6, further comprising:
generating a second video stream comprising the alert information associated with the at least one broadcasted alert message;
receiving a selection of the option to view alert information associated with the received broadcasted alert message; and
rendering the second video stream, via the dedicated broadcast channel, upon receiving the selection of the option to view alert information associated with the received broadcasted alert message.

8. The method of claim 7, wherein the alert information comprises at least one of the following: a source issuing the at least one broadcasted alert message; a location affected by the at least one broadcasted alert message; an effective time of the at least one broadcasted alert message; an alert type of the at least one broadcasted alert message; and a severity of the at least one broadcasted alert message.

9. A device for providing an alert message, the device comprising:
a network interface component configured to receive a broadcasted alert message from a network;
a memory component configured to store program code;
a processor in operative communication with the network interface component and the memory component, wherein the processor executes the program code, and wherein execution of the program code directs the device to:
render an alert messages interface comprising an indication of the received broadcasted alert message.

10. The device of claim 9, wherein the network interface component is further configured to receive audiovisual content.

11. The device of claim 10, wherein execution of the program code further directs the device to:
render a notification of the at least one broadcasted alert message over the audiovisual content; and
output the audiovisual content with the rendered notification.

12. The device of claim 11, wherein the notification comprises a graphical icon, and wherein the graphical icon is a pictorial representation of the at least one broadcasted alert message.

13. The device of claim 11, wherein the notification comprises a link to the alert messages interface, and wherein the program code directs the device to output the alert messages interface upon selection of the link.

14. The device of claim 9, wherein execution of the program code further directs the device to:
establish a channel; and
output the alert messages interface upon selection of the channel.

15. The device of claim 14, wherein the alert message interface comprises an option to view alert information associated with the broadcasted alert message.

16. The device of claim 15, wherein execution of the program code further directs the device to:
render an alert information interface comprising the alert information associated with the broadcasted alert message; and
provide the alert information interface in response to a selection of the option to view alert information associated with the received broadcasted alert message.

17. The device of claim 16, wherein the alert information interface is provided via the channel.

18. The device of claim 16, wherein the alert information comprises at least one of the following: a source issuing the at least one broadcasted alert message; a location affected by the at least one broadcasted alert message; an effective time of the at least one broadcasted alert message; an alert type of the at least one broadcasted alert message; and a severity of the at least one broadcasted alert message.

19. A system of providing a notification of alert messages, the system comprising:
a storage area for program code and data; and
a processor for executing the program code, wherein execution of the program code directs the system to:
receive a broadcasted alert message;
generate a first interface comprising an indication of the received broadcasted alert message; and
provide access to the first interface via an on-demand option.

20. The system of claim 19, wherein execution of the program code further directs the system to:
receive a selection of the on-demand option; and
render the first interface upon receiving the selection of the on-demand option.

21. The system of claim 20, wherein the first interface comprises an option to view alert information associated with the received broadcasted alert message.

22. The system of claim 21, wherein execution of the program code further directs the system to:
generate a second interface comprising the alert information associated with the received broadcasted alert message; and
render the second interface, via the on-demand option, in response to a selection of the option to view alert information associated with the received broadcasted alert message.

23. The system of claim 22, wherein the alert information comprises at least one of the following: a source issuing the at least one broadcasted alert message; a location affected by the at least one broadcasted alert message; an effective time of the at least one broadcasted alert message; an alert type of the at least one broadcasted alert message; and a severity of the at least one broadcasted alert message.
